(19) United States
(12) Patent Application Publication
(10) Pub. No.: US 2008/0059340 A1
(43) Pub. Date: Mar. 6, 2008

(54) Equipment management system

(75) Inventors: James William McCaherty, Chillicothe, IL (US); Abelardo Antonio Flores, Vina del Mar (CL); Paul Bruce Choberka, East Peoria, IL (US); Bob R. Nelson, Deer Creek, IL (US); Sergey N. Kislitsyn, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/513,287

(22) Filed: Aug. 31, 2006

(51) Int. Cl. G06Q 10/00

(52) U.S. Cl. 705/28

(57) ABSTRACT

An equipment management system includes a display and a processor. The processor may be configured to provide a first interface associated with an equipment planning and scheduling module, a second interface associated with a backlog management module, a third interface associated with a parts management module, and a fourth interface associated with a continuous improvement module. Further, the processor may be configured to receive data associated with the backlog management module via the second interface, data associated with the parts management module via the third interface, and data associated with the continuous improvement module via the fourth interface, supply at least some of the received data to the equipment planning and scheduling module, and output, to the display, at least a portion of an equipment management plan via the first interface, the equipment management plan being based on the data supplied to the equipment planning and scheduling module and based on at least one algorithm of the planning and scheduling module.

### TECHNICAL FIELD

This disclosure relates generally to managing and maintaining equipment and, more particularly, to an equipment management system directed to maximizing equipment availability.

### BACKGROUND

Maximizing equipment availability may be a goal of any production equipment owner and, therefore, production plans may be established based on characteristics and availability of resources assigned to achieve particular goals. If a piece of equipment or a component on a piece of equipment is not operational (e.g., scheduled or unscheduled maintenance and/or repairs, waiting for replacement parts, etc.) the equipment may not be productive, and the result may affect the achievement of production goals and revenue generation for the owner.

Equipment management (e.g., maintenance and repair) may be one useful tool for maximizing equipment availability. To ensure that a piece of equipment and its components are functioning at maximum availability, an equipment owner may perform routine maintenance and repairs, pre-operation checks, and component replacements, among other things, based on condition, fixed intervals, or otherwise as desired. For example, a machine may undergo routine oil changes at specified intervals, components may be inspected, and consumable parts (e.g., brake pads, hydraulic actuators, etc.) may be replaced as desired. However, this work still requires that a piece of equipment be taken out of production to undergo the maintenance work. Therefore, careful planning may be necessary to ensure that equipment downtime is reasonable, and that parts, labor, and facilities, among other things, required to complete the work are available at the time the piece of equipment is removed from production. Otherwise, costly delays and downtime for the equipment may result. Further, equipment may still break down (e.g., a leaking or ruptured hydraulic cylinder) regardless of applied maintenance routines, resulting in an unscheduled repair, added equipment downtime, and, therefore, greater revenue loss to the equipment owner. Therefore, one of ordinary skill in the art will recognize the importance, of an effective equipment management system and maintenance planning.

One system for managing an equipment maintenance program is disclosed in U.S. Pat. No. 6,598,940 to Sinex (“the '940 patent”). The '940 patent discloses a system including a maintenance review board program manager, an aircraft tracking manager, a dynamic aircraft maintenance production manager, a reliability manager, an electronic publications manager, and a personnel training manager. The modules of the '940 patent may work together to provide a listing of maintenance tasks, a dynamic maintenance program, an evaluation of part reliability, and employee assignments to maintenance tasks.

Although the '940 patent may provide a system for managing an equipment maintenance program, the '940 patent may lack certain functionality. For example, the '940 patent fails to disclose a parts and component management system integrated with a maintenance program manager. Failure to consider parts inventory, particularly in relation to a component of the equipment, when planning equipment maintenance and/or repair may lead to extended and costly downtime for a piece of equipment.

Further, the '940 patent fails to disclose a module for evaluating performance of previous maintenance activity and managing continuous improvement processes. Feedback related to the outcome and effectiveness of previously performed maintenance may be valuable for planning future maintenance on similar components. Moreover, lack of a defined continuous improvement process may cause an inefficient maintenance process to remain unidentified, resulting in potentially avoidable equipment downtime. Therefore, a comprehensive equipment management system and method may be helpful in ensuring maximum equipment availability.

The method of the present disclosure is directed towards overcoming one or more of the problems as set forth above.

### SUMMARY OF THE DISCLOSURE

In one aspect, the present disclosure is directed to an equipment management system. The system may include a display and a processor configured to provide a first interface associated with an equipment planning and scheduling module, a second interface associated with a backlog management module, a third interface associated with a parts management module, and a fourth interface associated with a continuous improvement module. The processor may further be configured to receive data associated with the backlog management module via the second interface, data associated with the parts management module via the third interface, and data associated with the continuous improvement module via the fourth interface. The processor may further be configured to supply at least some of the received data to the equipment planning and scheduling module and output, to the display, at least a portion of an equipment management plan via the first interface, the equipment management plan being based on the data supplied to the equipment planning and scheduling module and based on at least one algorithm of the planning and scheduling module.

In another aspect, the present disclosure is directed to a method for managing equipment. The method may include receiving data related to at least one piece of equipment, data related to a backlog management module, data related to a parts management module, and data related to a continuous improvement module, and providing at least some of the received data to a planning and scheduling module including an algorithm configured to generate an equipment management plan. The method may further include generating an equipment management plan based on the data and the at least one algorithm and outputting at least a portion of the equipment management plan.

In yet another aspect, the present disclosure is directed to an equipment management system. The equipment management system may include a display and a processor. The processor may be configured to provide a first interface associated with an equipment planning and scheduling module, a second interface associated with a backlog management module, a third interface associated with a parts management module, a fourth interface associated with a continuous improvement module, a fifth interface associated with a condition monitoring module, a sixth interface associated with a human resources module, a seventh interface associated with a preventive maintenance module, an eighth interface associated with a repair management module, a ninth interface associated with a component management module, and a tenth interface associated with a performance evaluation module. The processor may further be configured to receive data associated with any of the first through tenth interfaces, generate an equipment management plan based on the received data and based on an algorithm of the planning and scheduling module, and output, to the display, at least a portion of the equipment management plan.

### BRIEF DESCRIPTION OF THE DRAWINGS

FIG. 1 is a block diagram of a host computer system capable of implementing the methods and systems disclosed;

FIG. 2 is an exemplary illustration of modules which may be included in an equipment management system; and

FIG. 3 is an exemplary flowchart illustrating one method for utilizing an equipment management system consistent with the present disclosure.

### DETAILED DESCRIPTION

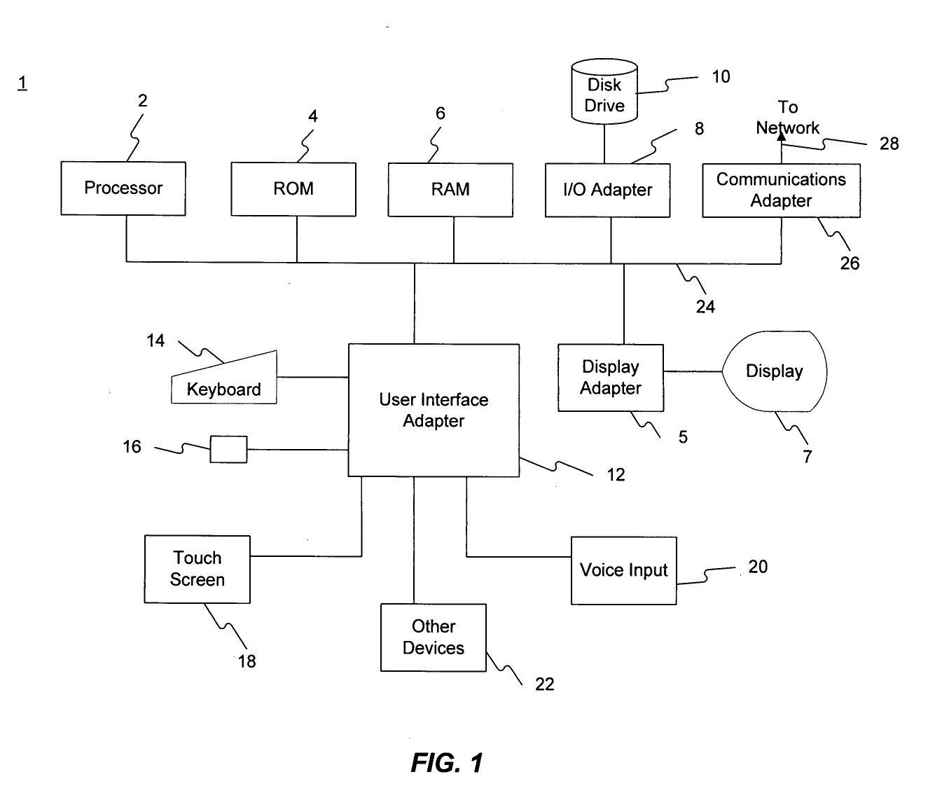

FIG. 1 is a block diagram of a host computer system 1 capable of implementing the methods and systems disclosed. Host computer system 1 may include a group of computer programs, program modules, and computer readable data stored on a computer readable media operating to cause computer system 1 to perform the actions described herein. Host computer system 1 may include a desktop or portable computer, a workstation, a server, a personal digital assistant, or any other computer system. Host computer system 1 may include a processor 2, a read-only memory (ROM) 4, and a random access memory (RAM) 6. Host computer system 1 may also include an input/output (I/O) adapter 8 for connecting peripheral devices such as disk drives 10. A user interface adapter 12 may be included for connecting input devices such as a keyboard 14, a mouse 16, a touch screen 18, a voice input 20 and/or other devices 22 to a system bus 24. A communications adapter 26 may connect host computer system 1 to a network 28, and a display adapter 5 may connect system bus 24 to a display 7.

In an exemplary embodiment, the disclosed methods and systems may be implemented as a computer program running on a computer. Furthermore, the methods and systems disclosed herein may be implemented using numerous operating environments such as, but not limited to, DOS, Linux, Windows, VMS, VAX, BeOS, Solaris, OS/2, Macintosh, UNIX, and any other suitable or future developed operating systems.

Processor 2 may execute instructions associated with an equipment management system which may be stored on disk drive 10, in RAM 6, or any other suitable location (e.g., a network location). Equipment as used herein includes machines, automobiles, devices, etc. Equipment may include mining equipment, hauling equipment, on-road equipment, etc. Equipment may also include powered equipment (e.g., including engines or motors) or unpowered equipment (e.g., a trailer). The equipment management system may receive data related to equipment management process modules to enable creation of an equipment management plan. The equipment management system may create the equipment management plan by applying the data to one or more algorithms included in the equipment management system. Processor 2 may then present information related to the equipment management plan (to display 7, for example) in the form of a report or other suitable data display methods.

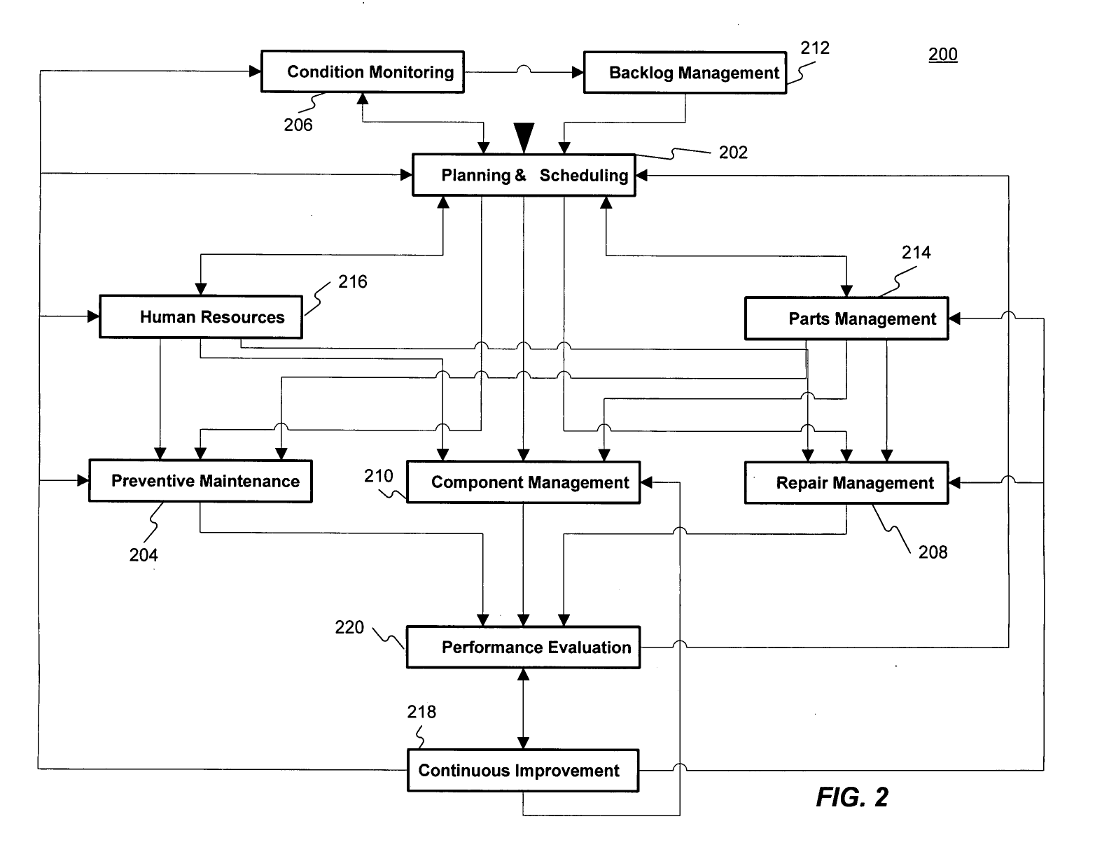

FIG. 2 is an exemplary illustration of modules which may be included in an equipment management system 200. Equipment management system 200 may include numerous modules related to managing equipment, planning equipment maintenance activities, and improving processes associated with equipment management. For example, equipment management system 200 may include a planning and scheduling module 202, a preventive maintenance module 204, a condition monitoring module 206, a repair management module 208, and a component management module 210. Equipment management system 200 may further include a backlog management module 212, a parts management module 214, a human resources module 216, a continuous improvement module 218, and a performance evaluation module 220. Modules within equipment management system may be software-based modules (e.g., software objects) or alternatively, diagrams, charts or other display type items (e.g., process maps printed on paper, transparencies, electronic files, etc.).

Modules included with equipment management system 200 may be associated with one or more interfaces and may further include sub-modules and related sub-interfaces. The interfaces and sub-interfaces may be used for data entry, review, and report generation, among other things. The associated interfaces may facilitate acquisition of data from paper-based forms, data entry, or via other suitable methods. For example, an interface associated with human resource module 216 may receive data via an employee work schedule database via network 28. In another example, parts management module 214 may receive data from users in a receiving department who update a parts availability and allocation database as parts are received. In yet another example, condition monitoring module 206 may receive data by a process of scanning paper-based inspection forms. In such an embodiment, data contained in the forms may then be extracted via optical character recognition (OCR) or other suitable processes, and/or the form may be stored in a text-and/or image format.

Items within a module may be accessed by clicking, double clicking, viewing, or other suitable method. Accessing such items may cause tasks or actions associated with the item to be displayed on display 7 or other suitable action to be taken. For example, upon accessing an item within a module, a process map associated with the item may be displayed on display 7. In another example, accessing an item within a sub-module may cause another level (e.g., a sub-sub-module) of related modules to be presented similar to a process sometimes referred to in the art as “drilling down.” Further, accessing an item within a sub-module may then cause processor 2 to present a digital representation of a paper-based form related to a sub-module step. For example, during planning, a task request may be initiated from planning and scheduling module 202. Accessing the task request item may cause processor 2 to present a related sub-module (e.g., task request). Such a sub-module may include several items related to a task request and organized into a task request process map. Previous planning and scheduling processes may have required that a paper form related to a task be filled out so that the task may be scheduled. Upon accessing a particular item within the task request sub-module, such a paper-based form may be represented for data entry on display 7, for example.

Modules associated with equipment management system 200 may be configured to receive data from one or more modules and/or interfaces. For example, planning and scheduling module 202 may be configured to receive labor availability data (e.g., specialty mechanic availability) from human resources module 216, task data from backlog management module 212, and part availability data from parts management module 214, among others. In another example, continuous improvement module 218 may be configured to receive data from planning and scheduling module 202 and performance evaluation module 220. In yet another example, a data extraction tool may extract equipment related data from paper forms and provide such data to planning and scheduling module 202. Further each module may communicate, individually or together, with an interface associated with a facility's dispatch or monitoring system to receive and provide information related to equipment. Any number of modules may receive data from any number of other modules within or outside equipment management system 200 without departing from the scope of the present disclosure.

Data may be provided to one module directly by other modules, or, alternatively, such data may be provided to planning and scheduling module 202, which, in turn, may provide the data to another module. For example, data related to availability of maintenance part kits may be provided by parts management module 214 to planning and scheduling module 202. Planning and scheduling module 202 may, in turn, provide the data to preventive maintenance module 204 or may wait for a request for the data from preventive maintenance module 204.

Modules associated with equipment management system 200 may also be configured to store received data and may archive such data for later use. Data may be stored in a database, a computer file, paper-based forms, in computer RAM (e.g., as object data), etc. For example, planning and scheduling module 202 may receive data from human resources module 216 indicating a work schedule for a mechanic. Planning and scheduling module 202 may store the work schedule in a computer file to facilitate planning future tasks utilizing the mechanic's time. Alternatively, planning and scheduling module 202 may share a common communication link to a database storing data related to equipment management system 200. In such an embodiment, planning and scheduling module 202 may access data related to human resources module 216 via a communicative link to the common database. One of ordinary skill in the art will recognize that other data storage and access configurations among other modules of equipment management system 200 (e.g., parts management module 214, condition monitoring module 206, etc.) may be utilized without departing from the scope of this disclosure.

Modules associated with equipment management system 200 may also be configured to provide data to one or more modules within equipment management system 200. For example, when planning and scheduling an equipment oil change, planning and scheduling module 202 may provide estimated time-to-complete data (e.g., oil change time is 30 minutes) to performance evaluation module 220 and part requirement data to parts management module 214 (e.g., oil filters are nearly or completely out of stock). Such data may facilitate the performance of functions of the responsible modules within equipment management system 200. For example, continuous improvement module 218 may utilize data provided by planning and scheduling module 202 such as, scheduled repair time, actual repair time, and scheduled repair steps to determine how a repair process may be improved and repair time minimized. In another example, parts management module 214 may provide data related to parts availability to repair management module 208 and human resources module 216 may provide information related to mechanic availability for performance of the task.

Modules associated with equipment management system 200 may also perform other tasks within equipment management system 200. For example, modules may be configured to issue alerts or warnings based on the status of a particular task. In such an embodiment, parts management module 214 may cause an alert or warning to be issued while also notifying planning and scheduling module 202 when a part required for a maintenance task will not be available on the scheduled date. This may alert a user to the change and allow other adjustments accordingly.

Planning and scheduling module 202 may include processes and procedures related to planning and scheduling activities associated with equipment management (e.g., maintenance and repair), among other things. For example, planning and scheduling module 202 may include one or more process maps related to planning and scheduling of equipment maintenance and repair. A process map, as used herein, means any flowchart, series of steps, diagrams, images, or other suitable devices for representing a process associated with a business operation. For example, an equipment management related planning and scheduling process map may represent steps in parallel and/or series, such as, ordering parts, scheduling mechanic time, scheduling facility time, scheduling equipment downtime, etc. Each of these steps may be represented in any fashion such that one of skill in the art may interpret the steps and determine how to proceed with a process. Representations may include flowcharts, Gantt charts, and/or any other suitable representation method.

Planning and scheduling module 202 may include one or more algorithms associated with planning and scheduling of equipment management related activities. Processor 2 may execute algorithms associated with planning and scheduling module 202 utilizing data received from other modules associated with equipment management system 200 and/or data received from an interface associated with planning and scheduling module 202. Such algorithms may be configured to output information related to an equipment management plan based on the data supplied to planning and scheduling module 202 and based on at least one algorithm of planning and scheduling module 202. Such information may include, for example, current task schedules, long term task schedules, and reports, among other things. For example, an equipment management plan may include activities to be undertaken with regard to equipment for short term (e.g., 1 week to 2 months), medium term (e.g., 2 months to 12 months), and/or long term (e.g., 1 to 3 or more years). An equipment management plan may also include information related to labor allocation for tasks, parts allocation, preventive maintenance intervals, etc. One of skill in the art will recognize that various types of information may be related to an equipment management plan and output from planning and scheduling module 202.

Planning and scheduling module 202 may further be configured to provide “what-if” type planning and scheduling assistance. For example, an operator may wish to examine several scenarios related to planning an equipment component replacement. Planning and scheduling module 202 may create several hypothetical scenarios related to the component replacement and/or may allow the operator to create several additional potentially desirable scenarios. Each scenario may utilize various inputs from various other modules related to equipment management system 200 (e.g., human resources module 216 and parts management module 214). The probable outcome of each of the scenarios may then be provided to the operator for evaluation.

Planning and scheduling module 202 may provide more or less functionality as desired without departing from the scope of the present disclosure. For example, planning and scheduling module 202 may enable daily, weekly, monthly, and beyond schedule generation. Further, planning and scheduling module 202 may facilitate planning for unscheduled repairs, should they arise. Further, planning and scheduling module 202 may also assist in adapting plans and schedules of small equipment fleets to larger fleets of equipment (e.g., following acquisition of additional equipment).

Preventive maintenance module 204 may include processes and procedures related to determining and executing methods related to preventive maintenance of equipment, among other things. Preventive maintenance may include processes related to maintaining a piece of equipment to minimize the probability of unscheduled downtime. For example, preventive maintenance module 204 may include process maps to assist in planning a preventive maintenance strategy, processes for creating and performing inspection checklists, and methods for importing an existing preventive maintenance strategy, among other things.

Preventive maintenance module 204 may include one or more algorithms associated with preventive maintenance for equipment. Processor 2 may execute algorithms associated with preventive maintenance module 204 utilizing data received from other modules associated with equipment management system 200 and/or data received from an interface associated with preventive maintenance module 204. Such algorithms may be configured to output information related to preventive maintenance of equipment based on the data provided to preventive maintenance module 204. Such information may include, for example, equipment specific maintenance tasks, preventive maintenance history, and parts requirements for a maintenance task, among other things. One of skill in the art will recognize that other types of information may be output from preventive maintenance module 204 without departing from the scope of the present disclosure.

Preventive maintenance module 204 may provide more or less functionality as desired without departing from the scope of the present disclosure. For example, preventive maintenance module 204 may enable generation of reports related to preventive maintenance tasks, viewing of preventive maintenance related task descriptions, etc. Integration with inspection checklists and fluid inspection reports (e.g., from condition monitoring module 206), among other things, may also be facilitated within preventive maintenance module 204. Further, preventive maintenance module 204 may facilitate preparation of preventive maintenance part kit definitions (e.g., oil change requires filter, gasket, and plug).

Condition monitoring module 206 may include processes and procedures related to monitoring equipment condition, among other things. Condition monitoring may include the processes of equipment inspection, fluid analysis, machine electronic data analysis, performance tests, application analysis failure/performance analysis, and other suitable processes for determining a state of a piece of equipment. For example, condition monitoring module 206 may include process maps and functionality related to creating editable inspection checklists, communications with on-board computers (e.g., engine computer), and analyzing/managing fluid inspection data (e.g., oil condition following an oil change), among other things.

1 Condition monitoring module 206 may include one or more algorithms associated with monitoring equipment condition. For example, condition monitoring module 206 may include an algorithm for analyzing oil samples taken during a scheduled predictive activity with the objective of assessing the condition of a specific component/system of the equipment. The algorithm may further recommend, based on the analysis, a maintenance corrective action where applicable. Other suitable algorithms may also be included within condition monitoring module 206. Processor 2 may execute algorithms associated with condition monitoring module 206 utilizing data received from other modules associated with equipment management system 200 and/or data received from an interface associated with condition monitoring module 206. Such algorithms may be configured to output information related to preventive maintenance of equipment based on the data provided to condition monitoring module 206. Such information may include, for example, equipment condition reports, equipment potential failure alerts, and assistance (e.g., pop-up help) for report interpretation, among other things. One of skill in the art will recognize that other types of information may be output from condition monitoring module 206 without departing from the scope of the present disclosure.

Condition monitoring module 206 may provide more or less functionality as desired without departing from the scope of the present disclosure. For example, condition monitoring module 206 may enable generation of equipment “hot-sheets” (i.e., an overall equipment systems or component health status sheet), and determinations of cost effectiveness for condition monitoring processes, among other things.

Repair management module 208 may include processes and procedures related to managing equipment repairs, among other things. Equipment repairs may be scheduled or unscheduled and may be related to preventive maintenance or may be undertaken to correct an equipment failure resulting in down time. Therefore, repair management module 208 may include process maps and functionality related to managing repairs, for example, matching personnel skills to a scheduled repair, tracking repair status (e.g., percent complete), and prioritizing an equipment hot-sheet, among other things.

Repair management module 208 may include one or more algorithms associated with monitoring equipment condition. For example, repair management module 208 may include an algorithm for prioritizing repairs from an equipment hot-sheet using the Pareto principle and mean time before shutdown (MTBS), mean time to repair (MTTR) data, availability data, cost data, and machine repair history relative to reference standards for MTBS, MTTR and availability and costs versus budgetary targets. Repair management module 208 may also include algorithms related to generating a shift transition report (e.g., a report containing notes to alert a mechanic on the next shift) and a real-time dispatch, among others. Processor 2 may execute algorithms associated with repair management module 208 utilizing data received from other modules associated with equipment management system 200 and/or data received from an interface associated with repair management module 208. Such algorithms may be configured to output information related to repair of equipment based on the data provided to repair management module 208. Such information may include, for example, visual progress reports, before and after analysis, and repair performance data, among other things. One of skill in the art will recognize that other types of information may be output from repair management module 208 without departing from the scope of the present disclosure.

Repair management module 208 may provide more or less functionality as desired without departing from the scope of the present disclosure. For example, repair management module 208 may enable generation of real-time equipment status updates (e.g., equipment is operating, equipment is on stand by, and equipment is non-operational), among other things.

Component management module 210 may include processes and procedures related to equipment component management, among other things. A component of a piece of equipment may be any collection of parts forming a unit. For example, a turbocharger component may include a series of parts such as a turbine, a compressor, a housing, and bearings. Component management may, therefore, include monitoring and repair of each component included in a piece of equipment. For example, component management module 210 may include process maps and functionality related to determining part kits for a component, determining availability of an entire component (e.g., rebuilt turbocharger), and organizing a repair based on assembly/disassembly of a component, among other things.

Component management module 210 may include one or more algorithms associated with managing components related to a piece of equipment. For example, component management module 210 may include an algorithm for forecasting a planned component replacement (PCR) based on usage, expressed in operated hours or any other suitable parameter, and conditions based on actual hours relative to life targets. Component management module 210 may also include algorithms related to generating a component hot-sheet and performing “what if” analysis, particularly as related to PCR. Processor 2 may execute algorithms associated with component management module 210 utilizing data received from other modules associated with equipment management system 200 and/or data received from an interface associated with component management module 210. Such algorithms may be configured to output information related to component management based on the data provided to component management module 210. Such information may include, for example, site-specific management strategies, equipment hot sheets, and long term component availability forecasts, among other things. One of skill in the art will recognize that other types of information may be output from component management module 210 without departing from the scope of the present disclosure.

Component management module 210 may provide more or less functionality as desired without departing from the scope of the present disclosure. For example, component management module 210 may interact with parts management module 214 (or other suitable module) to procure parts for a PCR or other task.

Backlog management module 212 may include processes and procedures related to managing tasks associated with equipment maintenance and management, among other things. Backlog management may be similar to management of a work list (e.g., “to-do” list) containing items to be performed on a particular piece of equipment and/or the entire equipment fleet. For example, a piece of equipment may require numerous items to be serviced and/or maintained to minimize the probability of failure and subsequent unscheduled downtime. Further, a piece of equipment that has failed and is currently experiencing unscheduled downtime may have numerous tasks scheduled to get the equipment up and running as quickly as possible. Backlog management module 212 may, therefore, organize and prioritize tasks with a goal of maximizing task efficiency or any other suitable metric, among other things. For example, backlog management module 212 may include process maps and functionality related to receiving information for a to-be completed task for a piece of equipment, identifying tasks to be completed according to equipment needs, determining availability of an entire component, and reporting based on task status, among others.

Backlog management module 212 may include one or more algorithms associated with managing to-be-completed tasks related to equipment. For example, backlog management module 212 may include an algorithm for interacting with parts management module 214 to confirm and/or procure parts for a task. Backlog management module 212 may also include algorithms related to processing and organizing newly received task requests (e.g., master cylinder on machine #3 should be replaced). Processor 2 may execute algorithms associated with backlog management module 212 utilizing data received from other modules associated with equipment management system 200 and/or data received from an interface associated with backlog management module 212. Such algorithms may be configured to output information related to backlog management based on the data provided to backlog management module 212. Such information may include, for example, task part listings, task priority/urgency, and task execution status, among other things. One of skill in the art will recognize that other types of information may be output from backlog management module 212 without departing from the scope of the present disclosure.

Backlog management module 212 may provide more or less functionality as desired without departing from the scope of the present disclosure. For example, backlog management module 212 may enable analysis of pending “ready-to-go” tasks (e.g., planned, scheduled, and parts/resources available) and registration of completed tasks, among other things. In addition, backlog management module 212 may coordinate with human resources module 216 (or other suitable module) to schedule labor for a task.

Parts management module 214 may include processes and procedures related to managing on- or off-site parts associated with equipment maintenance and management, among other things. Parts management may be similar to an inventory management of replacement parts for one or more pieces of equipment. For example, it may be desired that several parts are in stock and ready to install to prevent prolonged equipment delays and downtime. Parts management module 214 may, therefore, provide functionality related to tracking part availability and ensuring that such parts are maintained in stock, among other things. Parts management module 214 may include process maps and functionality related to monitoring part inventory, receiving information related to part use and receipt, and determining scheduling of a task requiring parts that are currently unavailable, among others.

Parts management module 214 may include one or more algorithms associated with managing on- or off-site parts inventory. For example, parts management module 214 may include an algorithm for interacting with component management module 210 to determine a parts kit for a component on a piece of equipment. Parts management module 214 may also include algorithms related to ordering and logging requested parts, among other things. Processor 2 may execute algorithms associated with parts management module 214 utilizing data received from other modules associated with equipment management system 200 and/or data received from an interface associated with parts management module 214. Such algorithms may be configured to output information related to parts management based on the data provided to parts management module 214. Such information may include, for example, timeframe for a planned component replacement, total parts cost per task, and part availability for fleet maintenance, among other things. One of skill in the art will recognize that other types of information may be output from parts management module 214 without departing from the scope of the present disclosure.

Parts management module 214 may provide more or less functionality as desired without departing from the scope of the present disclosure. For example, parts management module 214 may receive information from planning and scheduling module 202 such that parts may be ordered for upcoming preventive maintenance, among other things. In addition, parts management module 214 may coordinate with backlog management module 212 (or other suitable module) to reserve parts for upcoming tasks.

Human resources module 216 may include processes and procedures related to personnel within an organization, among other things. Personnel within an organization may have numerous data elements, including, for example, personnel availability, work schedules, and resumes, among other things. For example, data associated with human resources module 216 may indicate an employees training level and expertise. Human resources module 216 may, therefore, provide functionality related to pairing a particular employee with a task based on skill level and availability, among other things. Human resources module 216 may include process maps and functionality related to tracking skills inventory, receiving personnel information, and determining employee availability for tasks based on work schedules, among others.

Human resources module 216 may include one or more algorithms associated with managing personnel (e.g., work schedules, training, work history, etc.). For example, human resources module 216 may include an algorithm for interacting with repair management module 208 to determine an employee's long term repair performance (e.g., have repairs performed by “employee X” consistently failed?). Human resources module 216 may also include algorithms related to analyzing training associated with the employee pool to determine if additional training may be beneficial to increase availability. Processor 2 may execute algorithms associated with human resources module 216 utilizing data received from other modules associated with equipment management system 200 and/or data received from an interface associated with human resources module 216. Such algorithms may be configured to output information related to personnel based on the data provided to human resources module 216. Such information may include, for example, employee career development, skills availability for one or more repair facilities, and total organization competency, among other things. One of skill in the art will recognize that other types of information may be output from human resources module 216 without departing from the scope of the present disclosure.

Human resources module 216 may provide more or less functionality as desired without departing from the scope of the present disclosure. For example, human resources module 216 may receive information from continuous improvement module 218 indicating that training in a particular area may increase a process efficiency, among other things. In addition, human resources module 216 may coordinate with backlog management module 212 (or other suitable module) to reserve labor for upcoming tasks.

Continuous improvement module 218 may interact with processes and procedures related to continuous improvement processes (CIPs) within an organization (e.g., Shewart/Deming cycles), among other things. CIPs may interact with procedures designed to interact with all or some of the processes associated with modules of equipment management system 200, with the goal of improving such processes and procedures, among other things. For example, continuous improvement module 218 may communicate with performance evaluation module 220 to receive information beneficial for identifying candidate projects for a continuous improvement process.

Continuous improvement module 218 may include one or more algorithms associated with continuously improving equipment management processes. For example, continuous improvement module 218 may include an algorithm for identifying potential improvement areas in process maps associated with planning and scheduling module 202. Continuous improvement module 218 may also include algorithms related to analyzing tasks and task success rates. Processor 2 may execute algorithms associated with continuous improvement module 218 utilizing data received from other modules associated with equipment management system 200 and/or data received from an interface associated with continuous improvement module 218 (e.g., performance evaluation module 220). Such algorithms may be configured to output information related to CIPs based on the data provided to continuous improvement module 218. Such information may include, for example, assignment of potential improvement areas, suggested improvement steps, and estimated improvement benefits, among other things. One of skill in the art will recognize that other types of information may be output from continuous improvement module 218 without departing from the scope of the present disclosure.

Continuous improvement module 218 may provide more or less functionality as desired without departing from the scope of the present disclosure. For example, continuous improvement module 218 may provide reports indicating the number of CIPs currently active and the estimated time to complete implementation, among other things.

Performance evaluation module 220 may include processes and procedures related to evaluating equipment/fleet performance as well as the performance of processes and sub-processes within the overall system, among other things. Performance evaluation may include short and long term determinations of success of equipment management in optimizing equipment availability and other suitable performance metrics. For example, performance evaluation module 220 may generate reports tracking fleet and functional performance. Therefore, performance evaluation module 220 may include process maps and functionality related to quantifying performance metrics for evaluation.

Performance evaluation module 220 may include one or more algorithms for evaluating equipment/fleet performance as well as that of other tasks and processes. In one embodiment, performance evaluation module 220 may include an algorithm for identifying and calculating key performance indicators (KPIs) for processes and tasks. For example, such an algorithm may determine that one KPI related to equipment performance is mean time between shutdowns (MTBS). Performance evaluation module 220 may then monitor MTBS for a series of similar repairs to enable tracking, trending, and reporting of performance. Processor 2 may execute algorithms associated with performance evaluation module 220 utilizing data received from other modules associated with equipment management system 200 and/or data received from an interface associated with other inputs (e.g., dispatch system), among other things. Such algorithms may be configured to output information related to related to site, fleet and, process performance based on the data provided to performance evaluation module 220. Such information may include, for example, performance evaluations based on scheduled repairs, unscheduled repairs, and preventive maintenance, among other things. One of skill in the art will recognize that other types of information may be output from performance evaluation module 220 without departing from the scope of the present disclosure.

Performance evaluation module 220 may provide more or less functionality as desired without departing from the scope of the present disclosure. For example, performance evaluation module 220 may connection to a dispatch system for gathering equipment information and the ability to generate metrics related to operation, application, and production, among other things.

### INDUSTRIAL APPLICABILITY

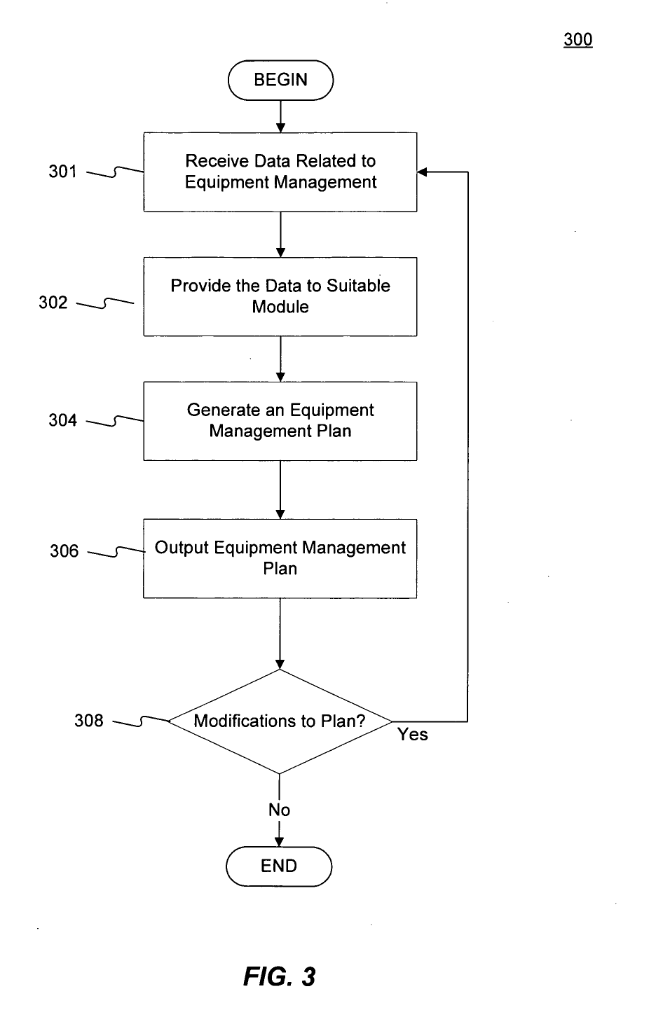

An equipment management plan may be helpful in maximizing equipment availability. FIG. 3 is a flowchart 300 illustrating an exemplary method for generating an equipment management plan consistent with the present disclosure. Data related to an equipment management plan may be received by equipment management system 200 (step 301). Data may be received via manual data entry, scanning of paper forms, retrieval from another system, or any other suitable data entry method. Data may be received utilizing an interface associated with a module of equipment management system 200 and/or using other techniques known in the art. At least some of the data may then be provided to one or more modules associated with equipment management system 200 (step 302). For example, data may be provided to planning and scheduling module 202, parts management module 214, and backlog management module 212. Once the data has been provided to the various modules, an equipment management plan may be generated (step 304). Following the generation of an equipment management plan, the plan may be output to display 7 and/or other suitable device (e.g., a printer) (step 306). The equipment management plan may then be reviewed to determine whether changes may be desired. For example, a user may be aware that a mechanic plans to take vacation during a particular scheduled maintenance time, but such data may not yet be entered in human resources component 216. The user may wish to modify the equipment management plan to reflect this information. Therefore, where changes are desired (step 308: yes), additional data may be received, and/or the equipment management planning process may be repeated. Alternatively, if no changes are desired, the equipment management plan may be utilized to generate a schedule for equipment management (step 308: no) unless and until future changes arise (e.g., unscheduled repairs).

The disclosed system and method for an equipment management system may ease the task of generating a comprehensive equipment management plan. Utilizing the system and method of the present disclosure may allow users to implement such a plan for a number of scenarios using any number of permutations to achieve a desired outcome (e.g., optimizing availability). By developing such a plan, users may create plans that can provide equipment availability greater than about 90 percent.

The present system and method may have several other advantages. Because the system includes a parts and component management module, a generated equipment management plan may take parts and component availability into consideration when planning equipment downtime. For example, where a planned hydraulic cylinder replacement is to be performed, parts management module 214, and other related modules, may ensure that the replacement task is not scheduled until the replacement cylinder and other related resources (e.g., labor, facility, etc.) are available. This may prevent unnecessary delays and costly equipment idle time.

In addition, the disclosed system and method include modules for evaluating performance of previous maintenance activity and managing continuous improvement processes. By receiving and evaluating feedback related to the outcome and effectiveness of previously performed maintenance, future maintenance on similar components may be revised and/or improved. Moreover, by allowing for the management of continuous improvement processes, inefficient or ineffective processes or sub-processes may be identified and revised which may lead to less equipment downtime, and, therefore, higher availability.

It is important to note that any of the modules, alone or in combination, and the process maps associated therewith, may be utilized as training and/or management aids. The modules and process maps may provide valuable insight for both prospective users and managers alike.

Further, the order in which steps and processes consistent with the disclosure described herein is exemplary only. It will be apparent to those skilled in the art that order of performance may not be important and the steps and processes may be performed in an order different than that described. Moreover, actions associated with each module described herein may or may not be performed by a user of the disclosed equipment management system based on desired results. Therefore, one of skill in the art will recognize that the description of such actions is intended to be exemplary only.

It will be apparent to those skilled in the art that various modifications and variations can be made in the disclosed equipment management system without departing from the scope of the disclosure. Additionally, other embodiments of the equipment management system will be apparent to those skilled in the art from consideration of the specification. It is intended that the specification and examples be considered as exemplary only, with a true scope of the disclosure being indicated by the following claims and their equivalents.

What is claimed is:

1. An equipment management system, comprising:
a display; and
a processor configured to:
provide a first interface associated with an equipment planning and scheduling module, a second interface associated with a backlog management module, a third interface associated with a parts management module, and a fourth interface associated with a continuous improvement module;
receive data associated with the backlog management module via the second interface, data associated with the parts management module via the third interface, and data associated with the continuous improvement module via the fourth interface;
supply at least some of the received data to the equipment planning and scheduling module; and
output, to the display, at least a portion of an equipment management plan via the first interface, the equipment management plan being based on the data supplied to the equipment planning and scheduling module and based on at least one algorithm of the planning and scheduling module.

2. The system of claim 1, wherein the at-least one algorithm is configured to generate an equipment management plan that provides equipment availability of greater than about 90 percent.

3. The system of claim 1, wherein at least one of the first, second, third, or fourth interfaces provides access to a related sub-interface.

4. The system of claim 3, wherein accessing the sub-interface enables display of at least one digital representation of a paper-based form related to the accessed sub-interface.

5. The system of claim 4, wherein the paper-based form is related to performance of an equipment related activity.

6. The system of claim 1, wherein the equipment management plan is configured to provide information related to equipment maintenance and repair activities for a period of up to 3 years.

7. The system of claim 1, wherein the processor is further configured to modify the information based on future changes to the data.

8. The system of claim 1, further including a data extraction module configured to obtain equipment related data from one or more of a paper-based form, a computer-based form, a relational database, and a file.

9. The system of claim 1, wherein the processor is further configured to provide a reporting interface configured to output a report related to the equipment management plan.

10. The system of claim 1, wherein the processor is further configured to provide:
a fifth interface related to a condition monitoring;
a sixth interface related to a human resources module;
a seventh interface related to a preventive maintenance module;
an eighth interface related to a repair management module;
a ninth interface related to a component management module; and
a tenth interface related to a performance evaluation module.

11. A method for managing equipment, the method comprising:
receiving data related to at least one piece of equipment, data related to a backlog management module, data related to a parts management module, and data related to a continuous improvement module;
providing at least some of the received data to a planning and scheduling module including an algorithm configured to generate an equipment management plan;
generating an equipment management plan based on the data and the at least one algorithm; and
outputting at least a portion of the equipment management plan.

12. The method of claim 11, further including:
receiving at least one modification to the received data; and
modifying the equipment management plan according to the modified data and the at least one algorithm.

13. The method of claim 11, further including:
receiving data related to a condition monitoring module;
receiving data related to a human resources module;
receiving data related to a preventive maintenance module;
receiving data related to a repair management module
receiving data related to a component management module; and
receiving data related to a performance evaluation module.

14. The method of claim 13, further comprising:
utilizing at least one of the planning and scheduling module, the parts management module, the backlog management module, the continuous improvement module, the human resources module, the component management module, the preventive maintenance module, the condition monitoring module, the performance evaluation module, the repair management module, or the equipment management plan as a training aid.

15. The system of claim 11, wherein the equipment management plan is configured to provide information related to equipment maintenance and repair activities for a period of up to 3 years.

16. The system of claim 11, further including extracting data from one or more of a paper-based form, a computer-based form, a relational database, and a computer file.

17. The method of claim 11, further including outputting a report related to the equipment management plan.

18. An equipment management system, comprising:
a display; and
a processor configured to:
provide a first interface associated with an equipment planning and scheduling module, a second interface associated with a backlog management module, a third interface associated with a parts management module, a fourth interface associated with a continuous improvement module, a fifth interface associated with a condition monitoring module, a sixth interface associated with a human resources module, a seventh interface associated with a preventive maintenance module, an eighth interface associated with a repair management module, a ninth interface associated with a component management module, and a tenth interface associated with a performance evaluation module;
receive data associated with any of the first through tenth interfaces;
generate an equipment management plan based on the received data and based on an algorithm of the planning and scheduling module; and
output, to the display, at least a portion of the equipment management plan.

19. The system of claim 18, wherein any of the first through tenth interfaces provides access to a related sub-interface and wherein accessing a sub-interface enables display of at least one digital representation of a paper-based form related to the accessed sub-interface.

20. The method of claim 18, wherein at least one of the planning and scheduling module, the parts management module, the backlog management module, the continuous improvement module, the human resources module, the component management module, the preventive maintenance module, the condition monitoring module, the performance evaluation module, or the repair management module is used as a training aid.
